(19) United States
(12) Patent Application Publication
(10) Pub. No.: US 2002/0198289 A1
(43) Pub. Date: Dec. 26, 2002

(54) Waterfast ink jet inks containing a UV curable resin

(76) Inventor: Joel J. Gummeson, Belchertown, MA (US)

Correspondence Address: LATHROP & GAGE LC, 2345 GRAND AVENUE, SUITE 2800, KANSAS CITY, MO, 64108, US

(21) Appl. No.: 10/075,438

(22) Filed: Feb. 14, 2002

Related U.S. Application Data
(60) Provisional application No. 60/268,767, filed on Feb. 14, 2001.

(51) Int. Cl. C08K 3/00

(52) U.S. Cl. 523/400

(57) ABSTRACT

An ink jet ink composition comprising (a) an aqueous carrier medium, (b) a colorant, (c) a UV curable resin dilutable in the aqueous carrier medium, and (d) a photoinitiator, a method for forming a waterfast image on an image receiving substrate comprising applying in imagewise fashion to the image receiving substrate by ink jetting an ink jet ink of the invention, and thereafter exposing the image receiving substrate to a UV source, and articles produced therefrom.

### RELATED APPLICATION

This application is a nonprovisional application which claims the priority of prior provisional application serial number 60/268,767 entitled “Waterfast Ink Jet Inks Containing A UV Curable Resin”, filed Feb. 14, 2001, which is hereby incorporated by reference into this application.

### BACKGROUND OF THE INVENTION

This invention relates to waterfast ink jet ink compositions containing a UV curable resin. This invention also relates to a method of forming an image on a substrate using the ink jet ink compositions of the invention. This invention further relates to a substrate having an ink jet image printed thereon using the ink jet ink compositions of the invention.

Ink jet printing is a non-impact printing method that produces droplets of ink that are deposited on a substrate such as paper or transparent film in response to an electronic digital signal. Thermal or bubble jet drop-on-demand ink jet printers have found broad application as output for personal computers in the office and in the home.

Ink jet printing processes and apparatus for such processes are well known in the art. In thermal ink jet printing processes, the printer typically employs a resistor element in a chamber provided with an opening for ink to enter from a plenum. The plenum is connected to a reservoir for storing the ink. A plurality of such resistor elements are generally arranged in a particular pattern, called a primitive, in a printhead. Each resistor element is associated with a nozzle in a nozzle plate, through which ink is expelled toward a print medium, such as paper. The entire assembly of printhead and reservoirs comprises an ink jet pen. In operation, each resistor element is connected via a conductive trace to a microprocessor, where current-carrying signals cause one or more selected elements to heat up. The heating creates a bubble of ink in the chamber, which is expelled through the nozzle toward the print medium. In this way, firing of a plurality of such resistor elements in a particular order in a given primitive forms alphanumeric characters, performs area-fill, and provides other print capabilities on the medium. The thermal ink jet printing process is described in more detail, for example, in U.S. Pat. No. 5,169,437 to You and U.S. Pat. No. 5,207,824 to Moffatt et al., the entire disclosures of which are incorporated herein by reference.

It is necessary that the ink being used in this process meet various stringent performance characteristics. Such performance characteristics are generally more stringent than those for other liquid ink applications, such as for writing instruments (e.g., a fountain pen, felt pen, etc.). In particular, the following conditions are generally required for inks utilized in ink jet printing processes:

(1) the ink should possess liquid properties such as viscosity, surface tension and electric conductivity matching the discharging conditions of the printing apparatus, such as the form and material of printhead orifices, the diameter of orifices, etc.;

(2) the ink should be capable of being stored for a long period of time without causing clogging of printhead orifices during use;

(3) the recording liquid should be quickly fixable onto recording media, such as paper, film, etc., such that the outlines of the resulting ink dots are smooth and there is minimal blotting of the dotted ink;

(4) the resultant ink image should be of high quality, such as having a clear color tone, high density, and high color gamut;

(5) the resultant ink image should exhibit excellent waterfastness (water resistance) and lightfastness (light resistance);

(6) the ink should not chemically attack, corrode or erode surrounding materials such as the ink storage container, printhead components, orifices, etc.;

(7) the ink should not have an unpleasant odor and should not be toxic or flammable; and

(8) the ink should exhibit low foaming and high pH stability characteristics.

Various inks for ink jet printing processes are known in the art. Generally, the ink jet inks used in the art are aqueous inks, comprising a major amount of water, a humectant and/or a co-solvent, and a dye. By selecting specific surfactants, humectants, dyes, or other components, it is possible to adjust the print characteristics of the resultant ink.

Although numerous ink jet inks are presently available, they generally do not meet all of the above-described requirements, while also providing excellent print quality on the wide variety of plain papers generally used in the home and office. Particularly, because these inks are generally waterbased, there is a problem of waterfastness.

Great effort has been expended in attempts to provide both dye-based and pigment-based ink jet inks having acceptable waterfastness while maintaining other desirable characteristics. However, there continues to be a demand for inks having all of the above-mentioned desirable characteristics.

The need continues to exist in the ink jet industry for improved ink jet inks that satisfy the above-described requirements while providing high quality, waterfast prints on a wide variety of recording media, including plain paper. Although some currently available ink jet inks may provide waterfast images with better substrate latitude, the inks are unacceptable in that they generally smear and have poor latency and maintainability characteristics. In addition, such inks are generally difficult to manufacture. Thus, there is still a need in the ink jet ink industry for improved waterfast black and colored inks that can be easily prepared and obtained at a lower cost.

There are several possible ways in which waterfastness can be achieved. One is through modification of the dye using complex organic synthesis. This method involves great amounts of chemical research, and therefore increased costs. An example of a synthetic dye is U.S. Pat. No. 5,230,733 to Pawlowski, wherein the dye is maintained at a basic pH in solution. When printed, the dye is neutralized by contact with the paper, causing lactone or lactim ring formation. The resulting dye is substantially waterfast on the paper. A second method used to achieve waterfastness is the use of pigments as colorants. While pigments are used in inks for ink jet printing, none to date have shown truly satisfactory adhesion to the print substrate. Third, hot melt inks can be employed. However, these inks generally have problems with pile height and are not abrasion resistant. Fourth, additives may be added to improve the interaction between the ink, specifically the dye and/or pigment, and the paper. However, it has been found that many additives are not compatible with the ink jet ink formulations.

A method of achieving waterfast ink jet images that is compatible with a wide range of ink jet ink formulations would be highly desirable. It has now been discovered that waterfast ink jet images can be readily achieved by incorporating a UV curable resin into ink jet ink formulations and subsequently curing the ink after the image has been formed using a UV light source.

### SUMMARY OF THE INVENTION

According to the invention, an ink jet ink composition is provided comprising (a) an aqueous carrier medium, (b) a colorant, (c) a UV curable resin dilutable in the aqueous carrier medium, and (d) a photoinitiator.

Further according to the invention, a method of forming a waterfast image on an image receiving substrate is provided comprising (a) applying in imagewise fashion to the image receiving substrate by ink jetting an ink jet ink comprising (1) an aqueous carrier medium, (2) a colorant, (3) a UV curable resin dilutable in the aqueous carrier medium, and (4) a photoinitiator, and (b) thereafter exposing the image receiving substrate to a UV source.

Still further according to the invention, a method to improve the waterfastness of an ink jet image on a substrate is provided, the method comprising adding to an ink jet ink formulation an effective amount of a UV curable resin dilutable in the ink jet ink formulation and an effective amount of a photoinitiator, ink jetting an image on the substrate, and thereafter exposing the substrate to a UV source.

Still further according to the invention, an article produced by applying the ink jet ink compositions of the invention to a substrate and curing the image formed on the substrate by exposing the substrate to a UV source is provided.

Still further according to the invention, an ink jet printer ink cartridge is provided, the ink cartridge containing an ink jet ink composition of the invention.

### BRIEF DESCRIPTION OF THE DRAWINGS

Not Applicable.

### DETAILED DESCRIPTION OF THE INVENTION

A first embodiment of the invention relates to an ink jet ink composition comprising (a) an aqueous carrier medium, (b) a colorant, (c) a UV curable resin dilutable in the aqueous carrier medium, and (d) a photoinitiator.

UV curable resins that can be employed according to the invention are dilutable in the aqueous carrier medium, and preferably dilutable in water, i.e. water dilutable. As used herein with respect to the UV curable resins, “dilutable” means the UV curable resin dissolves in the aqueous carrier medium or can be dispersed in the aqueous carrier medium to solutions or dispersions with a solids content high enough for processing and dilutable further in water to be used with the inkjet printer of choice. Suitable UV curable resins, particularly oligomers or prepolymers, will be compatible with colorants used in the ink jet inks of the invention, and preferably have a high enough molecular weight to render the ink jet inks of the invention physically drying before UV curing.

The molecular weight of the UV curable resins can be any molecular weight suitable for use in the ink jet ink composition of the invention. Preferably the UV curable resins have a number average molecular weight (Mₙ) ranging from about 600 to about 4000, preferably about 800 to about 3500. Preferably the UV curable resins have a weight average molecular weight (M_{w}) ranging from about 2,000 to about 10,000, preferably about 2,500 to about 9,000.

The minimum T_{g} (glass transition temperature) of the UV curable resins is preferably greater than about 21° C. It is also preferable that the UV curable resins have a T_{g} greater than about 30° C. if it is advantageous to have the ink rendered dry to touch, i.e. physically drying, after water evaporation and prior to UV curing. The UV curable resins preferably have a T_{g} in the range of about 25° C. to about 45° C., and more preferably about 30 to about 45° C.

The suitable UV curable resins will also have a small enough particle size so as not to result in clogging of commercial ink jet heads or nozzles. A smaller particle size is preferred since this will reduce the chance of forming aggregates that could potentially plug the ink jet printing head or nozzle. Typical UV curable resins of the invention have a mean particle size of about 30 to about 80 nanometers. While UV curable resin with a mean particle size of about 70 to about 80 nanometers have been successfully used in the ink jet ink compositions of the invention, it is preferred to have a mean particle size in the range of about 30 nanometers to about 50 nanometers for longevity of the cartridge, particularly if the cartridge is to be refilled and reused. Examples of suitable UV curable resins include, but are not limited to, urethane resins, acrylic resins, polyester resins, epoxy resins, and mixtures thereof, wherein the UV curable resins preferably contain a sufficient level of unsaturation, e.g. carbon-carbon double bonds, or epoxide groups to enable the resin to photopolymerize at a rate practical for the desired printing speed. The resins can be from any backbone, but an aliphatic backbone is currently preferred for uses where the final printed article must have the optimum UV durability. Typically, the unsaturation is obtained from acrylate or methacrylate functionality, but is not limited to such functionality.

UV curable urethane resins, acrylic resins, polyester resins, and epoxy resins suitable for use in the invention are known in the art. Examples of suitable UV curable resins include, but are not limited to, those urethane resins described in U.S. Pat. Nos. 5,596,065 and 5,990,192, which are incorporated by reference herein in their entirety, polyester resins described in U.S. Pat. No. 6,265,461, corresponding to EP 0 982 339, which is incorporated by reference herein in its entirety. An example of a suitable polyester resin is Viaktin® VTE 6166, available from Solutia Inc., St. Louis, Mo.

The urethane acrylate resins of U.S. Pat. No. 5,596,065 are produced in accordance with the following process. The process for the preparation of water-dilutable urethane resins comprises reacting (A) hexamethylene diisocyanate, a total of about 50 mol % of whose NCO groups are in the form of urethane groups due to reaction of the hexamethylene diisocyanate with (i) one or more alcohols containing (meth)acryloyl groups and optionally with (ii) one or more aliphatic monoalcohols, with (B) from 0.25 to 0.45 mol per mol of (A) of 2,2-bis-(hydroxymethyl)propionic acid at from 70 to 90° C. until complete reaction of the hydroxyl groups has taken place, to obtain intermediate (AB) groups, and then reacting the intermediate (AB) with (C) from 0.2 to 0.45 mol per mol of (A) of one or more of an aliphatic or cycloaliphatic diisocyanate, a total of about 50 mol % of whose NCO groups are in the form of urethane groups due to reaction with (i) one or more alcohols containing (meth)acryloyl groups and, optionally, with (ii) one or more aliphatic monoalcohols, at from 100 to 110° C. until complete reaction of the remaining free isocyanate groups to give allophanate groups has taken place thereby giving a reaction product (ABC), wherein the molar ratios of components (A), (B), and (C) is such that the ratio of equivalents of the isocyanate groups and hydroxyl groups present in the original raw materials for component (A), (B), and (C) is from 1.1:1 to 1.45:1; and wherein the reaction product (ABC) contains carboxyl groups corresponding to an acid number of from 25 to 50 mg of KOH/g, and wherein at least 45% of the carboxyl groups of (ABC) are then neutralized with (D) an alkali metal hydroxide, optionally as a mixture with (E) an aliphatic or cycloaliphatic diisocyanate whose NCO groups are reacted to the extent of about 50 mol % each with one or more alcohols containing (meth)acryloyl groups and the remaining NCO groups are reacted with one or more N,N-dialkyl-alkanolamines, to form urethane groups, wherein the end product has a double bond equivalent (number of moles of ethylenic double bond per 1000 g of resin as solid) of from 1.5 to 3.5 mmol/g.

The urethane acrylate resins of U.S. Pat. No. 5,990,192 are produced in accordance with the following processes. One process for the preparation of water-dilutable urethane resins comprises reacting, in a first reaction step, (A) 1.0 mol of a cycloaliphatic and/or aromatic diisocyanate with a mixture (B1) of a (meth)acryloyl-containing dihydroxy compound in an amount such that the amount of reactive hydroxyl groups present therein is from 0.2 to 0.6 mol, and (B2) of a tri- or tetrahydric polyol which has been partly esterified with (meth)acrylic acid and has a residual average hydroxyl functionality of from 1.0 to 1.4 in the molecule, in an amount such that the amount of the reactive groups is from 0.4 to 0.8 mol, the amounts of (B1) and (B2) being chosen so that the sum of the amounts of the reactive hydroxyl groups of (B1) and (B2) in the first step is always 1.0 mol, in such a way that from about 40 to about 60%, preferably from about 45 to about 55% and, with particular preference, 50% of the isocyanate groups of (A) are converted into urethane groups, and subsequently, in a second step, reacting the resulting intermediate with (C) an aliphatic saturated monocarboxylic acid having at least two hydroxyl groups, in an amount such that the amount of the reactive hydroxyl groups is from 0.6 to 1 mol, until the hydroxyl groups (C) have undergone complete reaction, and, if desired, in a third step reacting this product with further polyol (B2) in an amount such that the amount of hydroxyl groups of this portion of (B2) is from 0 to 0.5 mol, until the remaining free isocyanate groups have undergone complete reaction, the molar proportions of the components (A) to (C) in all three steps being chosen so that the number of isocyanate groups present in component (A) and the number of hydroxyl groups present in total in components (B1), (B2) and (C) are in a ratio to one another of from 0.9:1 to 1:1 and the reaction product possesses carboxyl groups in accordance with an acid number of from 20 to 40 mg/g and has a specific double bond content (molar amount of ethylenic double bonds relative to the mass of the urethane resin solids) of not more than 3.5 mol/kg.

These resins can be formulated as aqueous dispersions or solutions provided that some, preferably at least 40%, of the carboxyl groups present in the resin are converted to carboxylate groups by adding neutralizing agents such as alkali metal hydroxides or tertiary amines, before the product is mixed with water. The partially neutralized resin can then be subjected to normal or inverse dispersion (incorporating the resin into water or water into the resin, in either case with stirring), preferably under shear exerted by high-speed stirrers, dissolver discs, ultrasound dispersers or dispersers operating in accordance with the rotor-stator principle.

Another process for preparing these polyurethane resins which comprises up to three stages and in whose first stage (A) 1.0 mol of a cycloaliphatic and/or aromatic diisocyanate is reacted with a mixture (B) comprising (B1) a (meth)acryloyl-containing dihydroxy compound and (B2) a tri- or tetrahydric polyol which has been partly esterified with (meth)acrylic acid and has a residual average hydroxyl functionality of from 1.0 to 1.4 in the molecule, the amounts of (B1) and (B2) being chosen so that the amount of the reactive hydroxyl groups in (B1) (n_{OH}(B1)) is from 0.2 to 0.6 mol, and the amount of the reactive hydroxl groups in (B2) (n_{OH}(B2) is from 0.8 to 0.4 mol, the sum n_{OH}(B1)+n_{OH}(B2) always being equal to 1 mol, in such a way that 50% of the isocyanate groups of (A) are converted into urethane groups, and, in the second stage, the resulting intermediate is subsequently reacted with (C) from 0.3 to 0.5 mol of 2,2-bis-(hydroxymethyl)propionic acid until the hydroxyl groups of (C) have undergone complete reaction, and if desired, in the third stage, the product is reacted with further polyol (B2) in an amount such that the amount of hydroxyl groups of (B2) is from 0 to 0.5 mol, until the remaining free isocyanate groups have undergone complete reaction. The molar proportions of the components (A) to (C) are in a ratio to one another of from 0.9:1 to 1:1 and the reaction product possesses carboxyl groups in accordance with an acid number of 20 to 40 mg/g and has a specific double bond content (molar amount of ethylenic double bonds relative to the mass of the urethane resin solids) of not more than 3.5 mol/kg.

DIN 53402 defines the acid number as the quotient of that mass M_{KOH} of potassium hydroxide which is required to neutralize a sample for analysis, and the mass m_{B} of this sample (mass of the solid in the sample in the case of solutions or dispersions); its customary unit is “mg/g.”

The polyester resins of U.S. Pat. No. 6,265,461 are produced in accordance with the following process. The process for the preparation of the polyester resin composition AB comprises mixing or pre-condensing a water-soluble radiation-curable emulsifying resin A, which contains ester and/or acid groups and has an acid number from about 20 to about 300 mg/g (preferably from about 60 to about 250 mg/g), and a radiation-curable water-insoluble polymer B, which contains ester and/or ether groups. Resin A is a reaction product of an alkoxylated polyol A1 with at least 3 hydroxyl groups per molecule and 3 to 10 oxyalkylene units per molecule, these oxyalkylene units containing 2 to 4 carbon atoms, with an α,β-unsaturated carboxylic acid A2, with one free carboxyl group per molecule, and a carboxylic acid A3. Carboxylic acid A3 is selected from carboxylic acids A31, having at least two carboxylic groups wherein at least one of these is a secondary or tertiary carboxylic group (i.e. the carboxylic group is linked to a carbon atom which in turn are linked to two or three carbon atoms) as well as a further acid group selected from carboxylic acid groups, sulphonic and phosphoric acid groups, and carboxylic acids A32 with at least two carboxylic groups and at least one hydroxyl group which is acidic by adjacent electronegative substitution (with a pKa-value of up to about 8). Polymer B is a reaction product of aliphatic, linear, branched or cyclic alcohols B1 with compounds B2 selected from alkylene oxides B21 having 2 to 4 carbon atoms, aliphatic, linear, branched or cyclic dicarboxylic acids B22, having 3 to 8 carbon atoms, and aliphatic lactones B23 having 4 to 12 carbon atoms, as well as compounds B3 selected from α,β-unsaturated carboxylic acids with 1 to 2 carboxyl groups in the molecule.

The urethane and polyester resins of U.S. Pat. Nos. 5,596,065, 5,990,192, and 6,265,461 are currently preferred resins for use in the ink jet ink compositions of the invention. In addition, urethane and polyester resins that are physically drying before UV curing are more preferred for maximum flexibility in the ink jet printing process.

Suitable UV curable epoxy resins include, but are not limited to, cycloaliphatic epoxy resins, aliphatic epoxy resins, diglycidyl ethers of bisphenol A (DGEBA), epoxy phenol-Novolac resins, and diglycidyl ethers of bisphenol F (DGEBF). These epoxy resins can undergo photopolymerization in the presence of cationic photoinitiators. Other waterborne resins that are known to those skilled in the art to undergo photopolymerization in the presence of cationic photoinitiators can also be used.

For applications demanding the highest level of UV durability, the UV curable resin backbone is preferably acrylic or aliphatic urethane and the unsaturation has reactivity that requires relatively low levels of photoinitiator, since increased levels of photoinitiator could contribute to yellowing. The currently preferred UV curable urethane resins for use in the invention are urethane acrylate resins, with polyester urethane acrylate resins being particularly preferred. The currently preferred urethane acrylate resins are Viaktin® VTE 6169 Radiation Cure Resin, Viaktin® VTE 6165 and Viaktin® VTE 6155, all of which are available from Solutia Inc., St. Louis, Mo., with urethane acrylate resins Viaktin® VTE 6169 and Viaktin® VTE 6165 being more preferred. The amount of UV curable resin in the ink jet inks of the invention can be expressed in terms of weight percent based on the total of the non-aqueous carrier medium components in the ink jet ink. The amount of UV curable resin in the ink jet inks of the invention can be up to an amount wherein the colorant level is high enough to maintain a good image saturation. Broadly, the ink jet ink will contain about 5 to about 80 weight percent of the UV curable resin, preferably about 10 to about 60 weight percent, and most preferably about 20 to about 50 weight percent.

The aqueous carrier medium comprises water and, optionally, contains a co-solvent. Water is preferably deionized water. In embodiments where a co-solvent is used, it is preferred that the co-solvent is a miscible organic component. Examples of suitable co-solvents include, but are not limited to, ethylene glycol, propylene glycol, diethylene glycols, glycerine, dipropylene glycols, polyethylene glycols, polypropylene glycols, amides, ethers, carboxylic acids, esters, alcohols, organosulfides, organosulfoxides, sulfones such as sulfolane, alcohol derivatives, carbitol, butyl carbitol, cellusolve, ether derivatives, amino alcohols, ketones, N-methylpyrrolidinone, N-ethyl-pyrrolidinone, 2-pyrrolidone, cyclohexyl-pyrrolidone, hydroxyethers, amides, sulfoxides such as dimethyl sulfoxide, lactones, imidazole, and mixtures thereof.

When mixtures of water and one or more co-solvents are selected as the aqueous carrier medium, the ratio of water to co-solvent may be in any effective range. Typically, the ratio of water to co-solvent is from about 100:0 to about 30:70, preferably from about 97:3 to about 50:50, although the ratio can be outside these ranges. The non-water component of the aqueous carrier medium, when present, generally serves as a humectant and/or curl additive or a dye solubilizer, and typically has a boiling point higher than that of water.

The colorant for use in the ink jet ink compositions of the invention may be selected from any suitable water-soluble dye or pigment dispersion, or a combination thereof. The colorant can be anionic or cationic. Preferably, the colorant is anionic. The colorant may be present with or without a dispersing agent.

When dyes are used in the ink jet inks of the invention, any suitable commercially available dye may be used to impart the desired color characteristics to the ink jet ink. Both anionic and cationic dyes are well known for use in ink jet inks. Most ink jet ink dyes are anionic; however, cationic dyes may also be used. Anionic dyes are those in which a negative charge is localized on one atom or spread over the entire molecule. Cationic dyes are those in which a positive charge is localized on one atom or spread over the entire molecule.

Specific examples of anionic dyes include Bernacid Red 2BMN, Pontamine Brilliant Bond Blue A, Pontamine, Food Black 2, Carodirect Turquoise FBL Supra Conc. (Direct Blue 199, Carolina Color and Chemical), Special Fast Turquoise 8GL Liquid (Direct Blue 86, Mobay Chemical), Intrabond Liquid Turquoise GLL (Direct Blue 86, Crompton and Knowles), Cibracron Brilliant Red 38-A (Reactive Red 4, Aldrich Chemical), Drimarene Brilliant Red X-2B (Reactive Red 56, Pylam, Inc.), Levafix Brilliant Red E-4B (Mobay Chemical), Levafix Brilliant Red E-6BA (Mobay Chemical), Pylam Certified D&C Red #28 (Acid Red 92, Pylam), Direct Brill Pink B Ground Crude (Crompton & Knowles), Cartasol Yellow GTF Presscake (Sandoz, Inc.), Tartrazine Extra Conc. (FD&C Yellow #5, Acid Yellow 23, Sandoz, Inc.), Carodirect Yellow RL (Direct Yellow 86, Carolina Color and Chemical), Cartasol Yellow GTF Liquid Special 110 (Sandoz, Inc.), D&C Yellow #10 (Acid Yellow 3, Tricon), Yellow Shade 16948 (Tricon), Basacid Black X34 (BASF), Carta Black 2GT (Sandoz, Inc.), Neozapon Red 492 (BASF), Orasol Red G (Ciba-Geigy), Direct Brilliant Pink B (Crompton-Knolls), Aizen Spilon Red C-BH (Hodagaya Chemical Company), Kayanol Red 3BL (Nippon Kayaku Company), Levanol Brilliant Red 3BW (Mobay Chemical Company), Levaderm Lemon Yellow (Mobay Chemical Company), Aizen Spilon Yellow C-GNH (Hodagaya Chemical Company), Spirit Fast Yellow 3G, Sirius Supra Yellow GD 167, Cartasol Brilliant Yellow 4GF (Sandoz), Pergasol Yellow CGP (Ciba-Geigy), Orasol Black RL (Ciba-Geigy), Orasol Black RLP (Ciba-Geigy), Savinyl Black RLS (Sandoz), Dermacarbon 2GT (Sandoz), Pyrazol Black BG (ICI Americas), Morfast Black Conc A (Morton-Thiokol), Diazol Black RN Quad (ICI Americas), Orasol Blue GN (Ciba-Geigy), Savinyl Blue GLS (Sandoz, Inc.), Luxol Blue MBSN (Morton-Thiokol), Sevron Blue 5GMF (ICI Americas), and Basacid Blue 750 (BASF); Levafix Brilliant Yellow E-GA, Levafix Yellow E2RA, Levafix Black EB, Levafix Black E-2G, Levafix Black P-36A, Levafix Black PN-L, Levafix Brilliant Red E6BA, and Levafix Brilliant Blue EFFA, all available from Bayer; Procion Turquoise PA, Procion Turquoise HA, Procion Turquoise Ho5G, Procion Turquoise H-7G, Procion Red MX-5B, Procion Red H8B (Reactive Red 31), Procion Red MX 8B GNS, Procion Red G, Procion Yellow MX-8G, Procion Black H-EXL, Procion Black P-N, Procion Blue MX-R, Procion Blue MX-4GD, Procion Blue MX-G, and Procion Blue MX-2GN, all available from ICI Americas; Cibacron Red F-B, Cibacron Black BG, Lanasol Black B, Lanasol Red 5B, Lanasol Red B, and Lanasol Yellow 46, all available from Ciba-Geigy; Baslien Black P-BR, Baslien Yellow EG, Baslien Brilliant Yellow P-3GN, Baslien Yellow M-6GD, Baslien Brilliant Red P-3B, Baslien Scarlet E-2G, Baslien Red E-B, Baslien Red E-7B, Baslien Red M-5B, Baslien Blue E-R, Baslien Brilliant Blue P-3R, Baslien Black P-BR, Baslien Turquoise Blue P-GR, Baslien Turquoise M-2G, Baslien Turquoise E-G, and Baslien Green E-6B, all available from BASF; Sumifix Turquoise Blue G, Sumifix Turquoise Blue H-GF, Sumifix Black B, Sumifix Black H-BG, Sumifix Yellow 2GC, Sumifix Supra Scarlet 2GF, and Sumifix Brilliant Red 5BF, all available from Sumitomo Chemical Company; Intracron Yellow C-8G, Intracron Red C-8B, Intracron Turquoise Blue GE, Intracron Turquoise HA, and intracron Black RL, all available from Crompton and Knowles, Dyes and Chemicals Division; mixtures thereof, and the like. Dyes that are invisible to the naked eye but detectable when exposed to radiation outside the visible wavelength range (such as ultraviolet or infrared radiation), such as dansyl-lysine, N-(2-amino-ethyl)-4-amino-3,6-disulfo-1,8-dinaphthalimide dipotassium salt, N-(2-aminopentyl)-4-amino-3,6-disulfo-1,8-dinaphthalimide dipotassium salt, Cascade Blue ethylenediamine trisodium salt (available from Molecular Proes, Inc.), Cascade Blue cadaverine trisodium salt (available from Molecular Proes, Inc.), bisdiazinyl derivatives of 4,4′-diaminostilbene-2,2′-disulfonic acid, amide derivatives of 4,4′-diamino-stilbene-2,2′-disulfonic acid, phenylurea derivatives of 4,4′-disubstituted stilbene-2,2′-disulfonic acid, mono- or di-naphthyltriazole derivatives of 4,4′-disubstituted stilbene disulfonic acid, derivatives of benzithiazole, derivatives of benzoxazole, derivatives of benzimidazole, derivatives of coumarin, derivatives of pyrazolines containing sulfonic acid groups, 4,4′-bis(triazin-2-ylamino)stilbene-2,2′-disulfonic acids, 2-(stilben-4-yl)naphthotriazoles, 2-(4-phenylstilben-4-yl)benzoxazoles, 4,4-bis(triazo-2-yl)stilbene-2,2′-disulfonic acids, 1,4-bis(styryl)-biphenyls, 1,3-diphenyl-2-pyrazolines, bis(benzazol-2-yl) derivatives, 3-phenyl-7-(triazin-2-yl)coumarins, carbostyrils, naphthalimides, 3,7-diamino-dibenzothiophen-2,8-disulfonic acid-5,5-dioxide, other commercially available materials, such as C.I. Fluorescent Brightener No. 28 (C.I. 40622), the fluorescent series Leucophor B-302, BMB (C.I. 290), BCR, BS, and the like (available from Leucophor), and the like, are also suitable.

Examples of additional suitable dyes include, but are not limited to, anthraquinones; monoazo dyes; diazo dyes; phthalocyanines; aza[18]annulenes; formazan copper complexes; Bernacid Red (Berncolors, Poughkeepsie, N.Y.); Pontamine Brilliant Bond Blue; Berncolor A. Y. 34; Telon Fast Yellow 4GL-175; Basacid Black SE 0228 (BASF); the Pro-Jet series of dyes available from ICI, including Pro-Jet Yellow I (Direct Yellow 86), Pro-Jet Magenta I (Acid Red 249), Pro-Jet Cyan I (Direct Blue 199), Pro-Jet Black I (Direct Black 168), and Pro-Jet Yellow 1-G (Direct Yellow 132); Pro-Jet Fast Yellow, Cyan and Magenta (Zeneca Inc.); Aminyl Brilliant Red F-B (Sumitomo Chemical Co.); the Duasyn line of “salt-free” dyes available from Hoechst, such as Duasyn Direct Black HEF-SF (Direct Black 168), Duasyn Black RL-SF (Reactive Black 31), Duasyn Direct Yellow 6G-SF VP216 (Direct Yellow 157), Duasyn Brilliant Yellow GL-SF VP220 (Reactive Yellow 37), Duasyn Acid Yellow XX-SF VP413 (Acid Yellow 23), Duasyn Brilliant Red F3B-SF VP218 (Reactive Red 180), Duasyn Rhodamine B-SF VP353 (Acid Red 52), Duasyn Direct Turquoise Blue FRL-SF VP368 (Direct Blue 199), and Duasyn Acid Blue AE-SF VP344 (Acid Blue 9); mixtures thereof; and the like.

Examples of cationic dyes include the following from Crompton & Knowles Corp: Sevron Yellow L200 200%, Sevron Brilliant Red 4G 200%, Sevron Brilliant Red B 200%, Sevron Blue 2G, Sevron Black B1, Basic Black PSr, and Basic Black RX. Other cationic dyes may also be suitable for use in this invention.

In addition, the colorant for the ink jet ink compositions of the invention may be a pigment, or a mixture of one or more dyes and/or one or more pigments. The pigment may be black, cyan, magenta, yellow, red, blue, green, brown, mixtures thereof, and the like. Examples of suitable black pigments include various carbon blacks such as channel black, furnace black, lamp black, and the like, such as Levanyl Black A-SF (Miles, Bayer) CAB-O-JET 200™ and CAB-O-JET 300™(Cabot) and Sunsperse Carbon Black LHD 9303 (Sun Chemicals). Colored pigments include red, green, blue, brown, magenta, cyan, and yellow particles, as well as mixtures thereof. Illustrative examples of magenta pigments include 2,9-dimethyl-substituted quinacridone and anthraquinone, identified in the Color Index as CI 60710, CI Dispersed Red 15, CI Solvent Red 19, and the like. Illustrative examples of suitable cyan pigments include copper tetra-4-(octadecyl sulfonamido) phthalocyanine,

X-copper phthalocyanine pigment, listed in the Color Index as CI 74160, CI Pigment Blue, and Anthradanthrene Blue, identified in the Color Index as CI 69810, Special Blue

X-2137, and the like. Illustrative examples of yellow pigments that can be selected include diarylide yellow

3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33, 2,5-dimethoxy-4-sulfonanilide phenylazo-4′-chloro-2,5-dimethoxy acetoacetanilide, Permanent Yellow FGL, and the like. Additional examples of pigments include Normandy Magenta RD-2400 (Paul Uhlich), Sunsperse Quindo Magenta QHD 6040 (Sun Chemicals), Paliogen Violet 5100 (BASF), Paliogen Violet 5890 (BASF), Permanent Violet VT2645 (Paul Uhlich), Heliogen Green L8730 (BASF), Argyle Green XP-111-S (Paul Uhlich), Brilliant Green Toner GR 0991 (Paul Uhlich), Heliogen Blue L6900 and L7020 (BASF), Heliogen Blue D6840 and D7080 (BASF), Sudan Blue OS (BASF), PV Fast Blue B2GO1 (American Hoechst), Sunsperse Blue BHD 6000 (Sun Chemicals), Irgalite Blue BCA (Ciba-Geigy), Paliogen Blue 6470 (BASF), Sudan III (Matheson, Coleman, Bell), Sudan II (Matheson, Coleman, Bell), Sudan IV (Matheson, Coleman, Bell), Sudan Orange G (Aldrich), Sudan Orange 220 (BASF), Paliogen Orange 3040 (BASF), Ortho Orange OR 2673 (Paul Uhlich), Paliogen Yellow 152, 1560 (BASF), Lithol Fast Yellow 0991K (BASF), Paliotol Yellow 1840 (BASF), Novoperm Yellow FG 1 (Hoechst), Permanent Yellow YE 0305 (Paul Uhlich), Lumogen Yellow D0790 (BASF), Sunsperse Yellow YHD 6001 (Sun Chemicals), Suco-Gelb L1250 (BASF), Suco-Yellow D1355 (BASF), Hostaperm Pink E (American Hoechst), Fanal Pink D4830 (BASF), Cinquasia Magenta (DuPont), Lithol Scarlet D3700 (BASF), Tolidine Red (Aldrich), Scarlet for Thermoplast NSD PS PA (Ugine Kuhlmann of Canada), E. D. Toluidine Red (Aldrich), Lithol Rubine Toner (Paul Uhlich), Lithol Scarlet 4440 (BASF), Bon Red C (Dominion Color Company), Royal Brilliant Red RD-8192 (Paul Uhlich), Oracet Pink RF (Ciba-Geigy), Paliogen Red 3871K (BASF), Paliogen Red 3340 (BASF), and Lithol Fast Scarlet L4300 (BASF).

Additional suitable commercially available pigment dispersions include: the Hostafine® pigments available from Celanese Corporation, including Hostafine Black T, Hostafine Black TS, Hostafine Yellow HR, Hostafine Yellow GR, Hostafine Red FRLL, Hostafine® Rubine F6B, Hostafine® Blue B2G, and the like; pigment dispersions available from Bayer AG including Levanyl® Yellow 5GXZ-SF, and the like; pigment dispersions available from Degussa Company including Derussol® carbon black pigment dispersions comprising Derussol® Z350S, Derussol® VU 25/L, Derussol® 345, and Derussol(D 3450S; pigment dispersions available from BASF Corporation, including Disperse Black 006607, Luconyl® Yellow 1250, Basoflex Pink 4810, and Luconyl® Blue 7050, and the like; and pigment dispersions available from Sun Chemical Corporation including, Sunsperse® Red RHD 9365, Sunsperse® Magenta W83012, and the like. Other suitable pigments having the criteria set forth below can also be selected.

The preferred pigments for the ink jet inks of the present invention are nontoxic and AMES test negative materials (non-mutagenic carbon blacks and color pigments) that include nonmutagenic and noncarcinogenic pigments for safety reasons. For example, it is desired to have pigments, including carbon blacks and color pigments, that have a very low concentration of polyaromatic hydrocarbons, which are known to be carcinogenic or mutagenic. For illustrative purposes, nitropyrene, pyrene, tetracene, pentacene, and many other polyaromatic hydrocarbons in many commercial carbon blacks and color pigments are considered to be toxic at a concentration greater than 5 parts per million. Thus, it is desirable to limit the amount of such toxic polyaromatic hydrocarbons in the pigments to less than 5 parts per million for the preparation of nontoxic ink jet inks. Many commercial carbon blacks and colored pigments have a concentration of polyaromatic hydrocarbons exceeding 5 part per million and, therefore, the inks derived from such pigments are generally considered to be toxic or failing to pass the AMES test. However, many nontoxic carbon blacks and color pigments including Raven® 5250, Raven® 5750, Regal® 330, Black Pearl® 1300, Black Pearls® L, Vulcan® XC-7, Hostapem® pink E, Hostaperm® blue (a phthalocyanine derivative) and other pigments are generally used in toners and other imaging applications. Those carbon blacks and color pigments usually have a polyaromatic hydrocarbon content of less than 1 part per million which is below the limit of 5 parts per million that is considered toxic. They do not show positive response in the AMES test and are considered to be safe in toner and ink jet ink applications.

Preferably, in embodiments of the invention where pigments are used, the pigment particle size is as small as possible to enable a stable dispersion of the particles in the liquid vehicle and to prevent clogging of the ink channels or nozzle when the ink is used in an ink jet printer. Preferred particle average diameters are generally from about 0.001 to about 0.3 micron, although the particle size can be outside this range in specific embodiments. Preferably, at least 70% of the pigment particles should have an average particle diameter of less than about 0.1 micron for carbon blacks and 0.3 micron for color pigments.

In embodiments of the invention where dyes are used, the dye is present in the ink jet ink composition in any effective amount to provide a desired color. Typically the dye is present in an amount of from about 1 to about 15% by weight of the ink composition, and preferably from about 2 to about 8% by weight (wherein the amount refers to an amount of dye molecules present in the ink), although the amount can be outside this range. A mixture of dyes in the proportions desired to obtain a specific shade may also be employed.

Similarly, in embodiments of the invention where pigments are used, the pigment may be present in the ink jet ink composition in any effective amount. Typically the pigment is present in an amount of from about 1% to about 10% by weight of the ink composition and preferably from about 2% to about 8% by weight, although the amount can be outside of this range. Where both dyes and pigments are incorporated into the ink jet ink composition, the weight percentage of the combined colorant may be adjusted accordingly.

In embodiments of the invention, the pigment may be dispersed in the ink with one or more dispersants. The dispersants can be anionic, cationic, or nonionic. Preferred dispersants are ionic dispersants that have both ionic (capable of ionization in water) and hydrophobic (affinity for pigments) moieties. Suitable dispersants include, but are not limited to, anionic dispersants, such as polymers and copolymers of styrene sulfonate salts (such as Na+, Li+, K+, Cs+, Rb+, substituted and unsubstituted ammonium cations, and the like) or naphthalene sulfonate salts, (such as Na+, Li+, K+, Cs+, Rb+, substituted and unsubstituted ammonium cations, and the like), unsubstituted and substituted naphthalene sulfonate salts (e.g. alkyl, alkoxy, substituted naphthalene derivatives, and the like) and an aldehyde derivative (such as unsubstituted alkyl aldehyde derivatives including formaldehyde, acetaldehyde, propylaldehyde, and the like), mixtures thereof, and the like, either in solid form or water solutions. Examples of such dispersants include commercial products such as Versa® 4, Versa® 7 and Versa® 77 (National Starch and Chemical Co.); Lomar® D (Diamond Shamrock Chemicals Co.); Daxad® 19 and Daxad® K (W.R. Grace Co.); Tamol® SN (Rohm & Haas); and the like. The more preferred dispersants comprise naphthalene sulfonate salts, especially a condensation product of naphthalenesulfonic acid and formaldehyde, and its salts (such as Na+, Li+, K+, Cs+, Rb+, substituted and unsubstituted ammonium cations, and the like). Also, nonionic dispersants or surfactants can be used in ink jet inks of the present invention, such as ethoxylated monoalkyl or dialkyl phenols including Igepal® CA and CO series materials (Rhone-Poulenc Co.) and Triton® series materials (Union Carbide Company). These nonionic surfactants or dispersants can be used alone or in combination with the aforementioned anionic dispersants.

The ratio of pigment to aforementioned pigment dispersant(s) according to the invention ranges from about 1:0.01 to about 1:3, preferably from about 1:0.1 to about 1:1, and most preferably from about 1:0.15 to about 1:0.5. The ratio of naphthalene substituent to aldehyde (e.g. formaldehyde, acetaldehyde, etc.) in the aforementioned anionic dispersant condensation product is generally about 1:1, although this ratio can be different depending on the stoichiometry of the feedstock and reaction condition, and can readily be adjusted to obtain a dispersant having a desired molecular weight and the desired ratio of naphthalene substituent to aldehyde. The remainder of the dispersant may comprise nonactive ingredients such as water, solvent or humectant. The weight-average molecular weight of the dispersant is generally less than 20,000, preferably less than 13,000, and more preferably less than 10,000. The pigment dispersion should contain enough dispersant to stabilize the pigment particle dispersion, but not so much as to adversely affect properties of the dispersion such as viscosity, stability, and optical density. The dispersant should also be in appropriate amounts so as to minimize dry smear of the produced images on paper and transparencies.

The ink jet inks of the invention will contain a photoinitiator. Any conventional initiator of free radical photopolymerization can be used as photoinitiators such as disclosed in “UV & EB Curing Formulations for Printing Inks Coatings & Paints”, edited by Dr. R. Holman & Dr. P. Oldring and published by SITA-Technology, 203 Gardiner House, Broomhill Road, London SW18 England. If desired, additional co-initiators can be used. Suitable examples of photoinitiator systems include, but are not limited to, aromatic carbonyl compounds such as benzoin, benzoin alkyl ethers, such as the isopropyl or n-butyl ether, γ-substi-tuted acetophenones, preferably benzil ketals, such as benzil dimethyl ketal (available commercially as IRGACURE® 651, Ciba Specialty Chemicals Inc., Hawthorne, N.Y.), or a-halogen-substituted acetophenones, such as trichloromethyl-p-tert-butyl phenyl ketone or morpholinomethyl phenyl ketone (e.g. 2-methyl-1,4-(methylthio)phenyl-2-morpholino-propan-1-one (available commercially as IRGACURE® 907) and 2-benzyl-2-dimethylamino-1-(4-morpholino-phenyl)-butan-1-one (available commercially as IRGACURE® 369), or dialkoxyacetophenones, such as diethoxyacetophenone, or α-hydroxyacetophenones, such as a 50/50 mixture of 1-hydroxycyclohexyl phenyl ketone and benzophenone (available commercially as IRGACURE® 500) or 1-hydroxycyclo-hexyl phenyl ketone (available commercially as IRGACURE® 184); or 2-hydroxy-2-methyl-1-phenyl-1-propanone (available commercially as DAROCUR® 1173, Ciba Specialty Chemicals Inc., Hawthorne, N.Y.); or benzophenones, such as benzophenone or bis(4-dimethylamino)benzophenone (Michler's Ketone) or methyl-o-benzoyl benzoate; or a quinone or a thioxanthone in conjunction with an amine which carries at least one hydrogen atom at an α-carbon atom, such as anthraquinone, benzoquinone or thioxanthone in conjunction with bis(4-dimethyl-amino)benzophenone or triethanolamine; or a thioxanthone, for example an alkyl—or halogen-substituted thioxanthone, such as 2-isopropylthio-xanthone or 2-chloro-thioxanthone; or acyl phosphides. The preferred photoinitiators will depend on the UV curable resin used and will be readily apparent to those of ordinary skill in the art. The currently preferred photoinitiators for the preferred urethane resins are α-hydroxyaceto-phenones, such as a 50/50 mixture of 1-hydroxy-cyclohexyl phenyl ketone and benzophenone (IRGACURE® 500), 1-hydroxycyclohexyl acetophenone (IRGACURE® 184), and 2-hydroxy-2-methyl-1-phenyl-1-propanone (DAROCUR® 1173).

When a cationic photoinitiator can be used with the UV curable resin, any suitable cationic photoinitiator known to those skilled in the art can be used. Suitable cationic photoinitiators include, but are not limited to, onium salts selected from iodonium, sulfonium, phosphonium, arsonium, azonium, bromonium, or selenonium salts, and the like, and mixtures thereof. Particularly preferred cationic photoinitiators are the diaryl iodonium salts and their derivatives, the triaryl sulfonium salts and their derivatives, and the triphenyl phosphonium salts and their derivatives.

The amount of photoinitiator in the ink jet inks of the invention can be expressed in terms of weight percent based on the total of the non-aqueous carrier medium components in the ink jet ink. Broadly, the ink jet ink will contain about 1 to about 8 weight percent of the photoinitiator, preferably about 2 to about 7 weight percent, and most preferably about 3 to about 6 weight percent.

The ink jet inks of the invention also may contain a penetrant to avoid inter-color bleeding. The penetrant gives the ink a lower surface tension, generally less than about 55 dynes/cm at 25° C. and preferably less than about 45 dynes/cm. Preferably, the ink jet inks of the present invention have a surface tension of from about 20 to about 55 dynes/cm, and more preferably from about 30 to about 45 dynes/cm. The viscosity of the ink composition is usually less than about 15 cPs at 25° C. preferably from about 1 cP to about 8 cPs, and more preferably from about 1 cP to about 5 cPs.

Humectants may also be added to the inks of the invention to prevent water evaporation and pigment sedimentation. Additionally, certain humectants such as N-methyl-2-pyrrolidone and 2-pyrrolidone have been found to improve dye solubility in the ink and thus serve the dual role as humectant and co-solvent. In addition, some humectants such as 2-pyrrolidone have been found to resist ink build-up on jet faces during extended printing, which is preferred for cartridge refillability. When incorporated into the inks of the present invention, one or more humectants may be added to the ink in an amount of approximately 1% to 30% by weight of the ink composition to prevent sediment build-up on print heads. When present, such additives may include any of the various known humectants and co-solvents which include, but are not limited to, glycols, such as ethylene glycol, diethylene glycol, propylene glycol, dipropylene glycol, polyethylene glycol, polypropylene glycol, and the like; triols, such as glycerine, trimethylolpropane, triols containing 2 to 10 carbon atoms, and the like; diols containing 2 to 10 carbon atoms such as 1,5-pentanediols, 1,6-hexanediols, and the like; sulfoxides, such as dialkylsulfoxide, dimethylsulfoxide, alkylphenyl sulfoxides, and the like; sulfones, such as sulfolane, dialkyl sulfones, alkyl phenyl sulfones, and the like; amides, such as N,N-dialkyl amides, N,N-alkyl phenyl amides, N-methyl-pyrrolidinone, N-cyclohexylpyrrolidinone, N,N-diethyl-toluamide, and the like; ethers, such as alkyl ether derivatives of alcohol, etherdiols, and ethertriols including butylcarbitol, alkyl ethers of polyethyleneglycols, and the like; urea; betaine; as well as the thio (sulfur) derivatives of the aforementioned materials such as thioethyleneglycol, trithio- or dithio-ethyleneglycol, and the like; derivatives thereof; mixtures thereof, and the like.

The ink jet inks of the invention may optionally include a jetting aid such as polyethylene oxide. A preferred polyethylene oxide is one having a weight-average molecular weight of about 18,500 at a concentration of about 0.01-0.5% by weight of the ink composition, and preferably a concentration of less than 0.1% by weight. The jetting aid provides smooth jetting or jetting with low jitter.

Examples of buffering agents that may be included are agents such as sodium borate, sodium hydrogen phosphate, sodium dihydrogen phosphate, mixtures thereof and the like.

pH controlling agents may also be included in the ink, if desired. Examples of such pH controlling agents suitable for inks of the present invention include, but are not limited to, acids; bases, including hydroxides of alkali metals such as lithium hydroxide, sodium hydroxide and potassium hydroxide; phosphate salts; carbonate salts; carboxylate salts; sulfite salts; amine salts; amines such as diethanolamine and triethanolamine; mixtures thereof and the like. When present, the pH controlling agent is preferably included in an amount of up to about 10% by weight of the ink composition, preferably from about 0.001% to 5.0% by weight, and more preferably from about 0.01% to about 5% percent by weight, although the amounts can be outside these ranges.

Polymeric chemical additives can also be added to the ink jet inks of the present invention to enhance the viscosity of the ink. Suitable polymeric additives include, but are not limited to, water soluble polymers such as Gum Arabic, polyacrylate salts, polymethacrylate salts, polyvinyl alcohols, hydroxy propylcellulose, hydroxyethylcellulose, polyvinylpyrrolidinone, polyvinylether, starch, polysaccharides, polyethyleneimines derivatized with polyethylene oxide and polypropylene oxide, such as the Discole® series (DKS International, Tokyo, Japan); the Jeffamine® series (Huntsman Corp., Conroe, Tex.); and the like. Polymeric additives may be present in the ink jet inks of the invention in amounts of from 0 to about 10% by weight of the ink composition, preferably from about 0.001% to about 8% by weight, and more preferably from about 0.01% to about 5% by weight, although the amount can be outside these ranges.

Other optional additives for the ink jet inks of the invention include biocides such as Dowicil 150, 200, and 75, benzoate salts, sorbate salts, Proxcel® (available from ICI), and the like. When used, such biocides are generally present in an amount of from 0 to about 10% by weight of the ink composition, preferably from about 0.001% to about 8% by weight, and more preferably from about 0.01% to about 4.0% by weight, although the amount can be outside these ranges.

Other additives may also be added. For example, trimethylol propane may be added to the ink jet ink compositions to reduce paper curl or as an anti-cockle agent. These additives, such as trimethylol propane, generally have a solubility parameter in the range of from about 27 to about 35 MPa^{½}and preferably between 29 and 33 Mpa^{½}, and can bind to paper through hydrogen bonding. Other examples of such anti-curl agents include, but are not limited to, N-acetylethanolamine, N-N-diacetyl piperazine, triethylene glycol, N-(2-aminoethyl) ethanolamine, 1,4-butanediol, N-ethyl formamide, 2-methyl-1,5-pentanediol, 1,5-pentanediol, diethylene glycol, 2,2′-oxybisethanol, mixtures thereof and the like. Preferably, the concentration of such anti-curl agents in ink jet inks of the present invention is between about 5% and about 50% by weight of the ink composition and more preferably between about 10% and about 30% by weight.

Other suitable additives such as anti-mold agents, electrical conductivity adjustment agents, chelating agents and anti-rusting agents, for example, may also be added. Other additives are disclosed in U.S. Pat. No. 4,737,190 to Shimada et al., the entire disclosure of which is incorporated herein by reference.

The ink jet inks of the invention can be prepared by any process suitable for preparing aqueous-based inks. The pigmented ink is prepared by premixing the selected pigment(s) and dispersant in water. In the case of dyes, some of the same factors apply except that there is no dispersant present and no need for pigment deaggregation. The dye-based ink is prepared in a well agitated vessel rather than in dispersing equipment. Co-solvents may be present during the dispersion.

The dispersing step may be accomplished in a horizontal mini mill, a ball mill, an attritor, or by passing the mixture through a plurality of nozzles within a liquid jet interaction chamber at a liquid pressure of at least 1000 psi to produce a uniform dispersion of the pigment particles in the aqueous carrier medium.

It is generally desirable to make the pigmented ink jet ink in concentrated form. The concentrated pigmented ink jet ink, which is subsequently diluted to the appropriate concentration for use in the ink jet printing system. This technique permits preparation of a greater quantity of pigmented ink from the equipment. If the pigment dispersion is made in a solvent, it is diluted with water and optionally other solvents to obtain the appropriate concentration. If the pigment dispersion is made in water, it is diluted with either additional water or water soluble solvents to make a pigment dispersion of the desired concentration. By dilution, the ink is adjusted to the desired viscosity, color, hue, saturation density, and print area coverage for the particular application.

According to another embodiment of the invention a waterfast image is formed on an image receiving substrate by ink jetting the ink jet ink of the invention onto the image receiving substrate in imagewise fashion, and thereafter exposing the substrate to a UV source.

The ink is applied to a suitable substrate in an imagewise fashion. Application of the ink to the substrate can be by any suitable ink jet process compatible with aqueous-based inks, such as continuous stream ink jet printing and drop-on-demand ink jet printing.

By incorporating an effective amount of a UV curable resin that is dilutable in the ink jet ink formulation, a method of improving the waterfastness of the ink jet image on a substrate is provided.

Curing of the image formed from the inventive ink jet ink composition can be initiated via a source of ultraviolet light (UV). That is, while curing can be initiated by naturally occurring UV light, normally, a man-made source of UV is employed, e.g., to crosslink the polymeric matrix. The source of UV radiation can range widely such as a lamp mounted above a conveyor, a lamp mounted on a robot arm, a lamp mounted on the printer head, among other apparatus for supplying UV radiation. After ink jetting the inventive ink jet ink composition upon a suitable substrate, the image can be exposed to a source of UV light wherein the UV source is selected to have peak energy output at about the same wavelengths where the photoinitiator will absorb (range of about 200 to about 1500 millijoules/cm²@ approximately, but not limited to, 25-400 nm, which may vary with exposure time, distance from source and type of bulb), that initiates curing thereby locking or freezing the composition as a coating upon the substrate. The specific wavelength of UV can be tailored to satisfy a wide range of product uses, exposure times and distance from the composition to be cured; but, normally ranges from greater than about 25 to about 400 nm and having an output of about 0.5 to about 1.5 J/cm². In some cases, it is desirable to employ one or more UV sources that emit differing UV wavelengths either simultaneously or sequentially, e.g., lamps that emit differing wavelengths and/or by one type of lamp having a filter. Any high energy UV output will be operable for use in the invention. For example, good results have been obtained using a Fusion Systems brand UV processor with UV output generated by an H bulb. The performance can be optimized for a given system by changing the fingerprint of the UV output by selecting D, M, V and other lamps as the UV Spectral output.

The exposure time of the image formed from the inventive ink jet ink composition to the UV source is typically about 1 to about 10 seconds. The specific exposure time can be tailored depending upon the distance from the UV source, intensity of the source, relative speed between the composition to be cured and the UV source, among other parameters.

A wide variety of substrates are contemplated for use in the practice of the present invention, e.g., papers, fabrics, polymeric films, cellulosic films, glasses, metals, sintered metals, woods, carbon-based materials, ceramics, and the like.

Exemplary papers contemplated for use in the practice of the present invention include ragbond papers, coated papers (e.g., matte papers, semigloss papers, clear film papers, high gloss photographic papers, semi-gloss photographic papers, latex papers, color inkjet papers, presentation papers, and the like), heavy coated papers, opaque bond papers, translucent bond papers, vellum, papers treated for ink, dye or colorant receptivity, and the like.

Fabrics contemplated for use in the practice of the present invention include any fabric prepared from fibers which (naturally or by post-treatment) contain free hydroxyl and/or free carboxyl groups. Exemplary fibers from which suitable fabrics can be prepared include 100% cotton, cotton/polyester blends, polyesters, silks, rayons, wools, polyamides, nylons, aramids, acrylics, modacrylics, polyolefins, spandex, saran, linens, hemps, jutes, sisals, latexes, butyl rubbers, vinyls, polyamide fibers, aluminum, stainless steel, novoloids, fabrics treated for ink, dye or colorant receptivity, and the like, as well as combinations of any two or more thereof.

Exemplary polymeric films include poly(acrylonitrile), poly(butadiene styrene), polycarbonate, polyester treated for ink, dye or colorant receptivity, and the like.

Exemplary cellulosic films include cellulose acetate, cellophane, cellulose acetate butyrate, cellulose triacetate, ethyl cellulose, cellulose nitrate, rayons, and the like.

Exemplary metal substrates include steel, stainless steel, ferritic stainless steel, aluminum, chromium oxide, iron oxide, iron cobalt, nickel, chromium, molybdenum, tungsten, magnetite, nickel oxide, cobalt oxide, vanadium oxide, titanium oxide, zirconium oxide, silicon oxide, tin oxide, and the like.

An exemplary sintered metal substrate contemplated for use in the practice of the present invention is tungsten carbide.

A wide variety of ceramic substrates are contemplated for use in the practice of the present invention, including structural ceramic materials, piezoelectric materials, glass ceramics, magnetic ceramics, cermets, nonlinear dielectric ceramics, refractory ceramics, dry-film lubricants, composite materials, and the like. Examples of such materials include oxides (e.g., aluminum oxide, chromium oxide, iron oxide, nickel oxide, cobalt oxide, vanadium oxide, titanium oxide, zirconium oxide, silicon oxide, tin oxide, and the like), carbides (e.g., silicon carbide, hafnium carbide, and the like), borides, nitrides, suicides (e.g., molybdenum disilicide) titanates (e.g., barium titanate, lead-zirconium titanate, and the like), ferrites (e.g., barium ferrite, lead ferrite, strontium ferrite, nickel-zinc ferrite, manganese ferrite, and the like), niobates (e.g., lead niobate), sulfides (e.g., molybdenum disulfide), and the like, as well as mixtures of any two or more thereof.

The preferred substrates for use with the ink jet inks of the invention are papers, fabrics, polymeric films, and cellulosic films, with papers being especially preferred.

In accordance with yet another embodiment of the invention, there are provided articles produced by the above-described methods, employing the ink jet formulations described herein. Thus, according to the invention, the ink jet image applied to a substrate as described herein resists removal from said substrate due to its substantially improved waterfastness.

When articles according to the invention comprise a fabric substrate having an ink jet image printed thereon, the resulting image adheres sufficiently to said substrate to resist removal therefrom upon washing of said article. Thus, in contrast to the results with commercially available ink jet formulations, which tend to readily wash off, the invention formulations enable one to achieve the benefits of ink jet technology, without compromising the ability of the deposited image to remain in place as applied.

### EXAMPLES

### Identification and Source of Materials

| | |
|---|---|
| Viaktin ® VTE 6169 | Aliphatic urethane acrylate emulsion; |
| | Solutia Inc. |
| Viaktin ® VTE 6165 | Aromatic urethane acrylate emulsion; |
| | Solutia Inc. |
| Viaktin ® VTE 6166 | Polyester acrylate emulsion; Solutia Inc. |
| Jetsperse ® Carbon | Sun Chemical LJD-3107; dispersion of |
| Black Dispersion | water, carbon black pigment, and |
| | surfactant; total solids = 21% (range 20- |
| | 22%); pigment solids = 17% (range 16.5- |
| | 17.5%); particle size: mean: 88.1 nm, |
| | 10%: 48.8 nm, 50%: 83.8 nm, 90%: 132.1 |
| | nm, no measurable particles above 200 |
| | nm. |
| Diethylene glycol | Old World Industries |
| Liponic EG-1 | Glycereth-26; Lipo Chemicals (humectant) |
| Silwet ® L-7607 | Surfactant; Crompton Corp. |
| Lucirin ® TPO | Acylphosphine oxide photoinitiator; |
| | BASF AG |
| IRGACURE ® 500 | 1:1 mixture by weight of 1-hydroxy- |
| | cyclohexyl-phenyl-ketone and benzophe- |
| | none; photoinitiator; Ciba Specialty |
| | Chemicals Inc. |
| Ink Jet Ink 51629 | Ink Jet Specialties |

### Example 1

Three ink jet ink formulations using an aliphatic urethane acrylate UV curable resin (Viaktin® 6169) were prepared by mixing the Viaktin® 6169 resin, Jetsperse® carbon black dispersion, diethylene glycol, Liponic EG-1, Silwet® L-7607, and deionized water. The resulting mixture was stirred until it was completely homogeneous, i.e. uniformly dispersed. A photoinitiator blend (1:2 weight ratio of Lucirin® TPO and IRGACURE® 500) was subsequently added to and mixed with each ink jet formulation in a level of from 1 to 5 weight % based on total ink solids. The ink jet ink formulations prepared are shown in Table I. A commercially available ink jet ink (Ink Jet Specialties 51629), containing no UV resin or photoinitiator, was used as a control.

The ink jet ink samples, i.e. formulations containing the photoinitiator blend, were then applied to 20 pound Xerox 4024 copying paper with a cotton swab applicator in a “zig-zag” pattern. In the case of the control ink, containing no UV resin or photoinitiator, the sample was allowed to dry under ambient conditions (72° F.) for 15 minutes. The inks, modified with UV curable resin and photoinitiator, were exposed to 2 passes at 30 feet per minute with 1-600 watt/inch Fusion Systems “H” bulb. In another control example, the control ink was also processed with the same UV curing conditions.

The water resistance of the applied ink image was tested by rubbing a cotton swab applicator, saturated with distilled water, across the test image with 2 double strokes. The test image was rated according to the following scale: 0=very poor water resistance, 1=significant effect on ink, 2=some effect on ink, 3=slight effect on ink, 4=very slight effect on ink, 5=no effect on ink. The results can be found in Table II below.

TABLE I

| | | Formulation | | Formulation | | Formulation | |
|---|---|---|---|---|---|---|---|
| | | A | | B | | C | |
| | | % UV Resin | | | | | |
| | | 10% | | 20% | | 40% | |
| | Total | | Solid | | Solid | | Solid |
| Component | Solids | Wet Wt. | Wt. | Wet Wt. | Wt. | Wet Wt. | Wt. |
| Viaktin ® 6169 | 45.00% | 0.39 | 0.18 | 0.78 | 0.35 | 1.56 | 0.70 |
| Jetsperse ® | 17.00% | 9.26 | 1.58 | 8.24 | 1.40 | 6.18 | 1.05 |
| Diethylene Glycol | 0.00% | 2.02 | | 2.05 | | 2.11 | |
| Liponic EG-1 | 0.00% | 2.02 | | 2.05 | | 2.11 | |
| Silwet ® L-7607 | 0.00% | 0.20 | | 0.20 | | 0.21 | |
| Deionized Water | 0.00% | 36.11 | | 36.68 | | 37.83 | |
| Total Diluent Wt. | | 40.35 | | 40.99 | | 42.27 | |
| Tolid Solid Wt. | | | 1.75 | | 1.75 | | 1.75 |
| Total Weight | | 50.00 | | 50.00 | | 50.00 | |
| Percent Total Solids | | | 3.50% | | 3.50% | | 3.50% |

TABLE II
Water Resistance

| Photoinitiator Level | Formulation A | Formulation B | Formulation C |
|---|---|---|---|
| 1% on Total Ink Solids | 3 | 3 | 4 |
| 2% on Total Ink Solids | 3 | 4 | 4 |
| 3% on Total Ink Solids | 3 | 4 | 5 |
| 4% on Total Ink Solids | 3 | 4 | 5 |
| 5% on Total Ink Solids | 3 | 5 | 5 |
| Control (1) | 1 | — | — |
| Control (2) | 1 | — | — |

(1) No UV treatment
(2) UV treatment

The results of the water testing of the control ink demonstrates that in all instances, i.e. with or without UV treatment, the ink is significantly smudged or smeared with the water moistened cotton swab (rated as a 1) according to the rating scale employed. Ink formulations modified with the UV curable resins, followed by UV curing show only slight to no effect when tested with the water moistened cotton swab.

A larger sample of the inks modified with UV curable resin were also charged into the ink cartridge for a Hewlett Packard 680C ink jet based printer. This cartridge was used to demonstrate the printability of the UV resin modified irk of the invention in a typical commercially available printer. UV curable resin modified inks of the invention applied by means of the ink jet printer demonstrate that resins of the invention having a maximum particle size of 70-80 nanometers can be effectively utilized in the ink jet ink formulations of the invention.

### Example 2

Three ink jet ink formulations using an polyester acrylate UV curable resin (Viaktin® 6166) were prepared by mixing the Viaktin® 6166 resin, Jetsperse® carbon black dispersion, diethylene glycol, Liponic EG-1, Silwet® L-7607, and deionized water. The resulting mixture was stirred until it was completely homogeneous, i.e. uniformly dispersed. A photoinitiator blend (1:2 weight ratio of Lucirin® TPO and IRGACURE® 500) was subsequently added to and mixed with each ink jet formulation in a level of from 1 to 5 weight % based on total ink solids. The ink jet ink formulations prepared are shown in Table III.

The ink jet ink samples, i.e. formulations containing the photoinitiator blend, were then applied to 20 pound Xerox 4024 copying paper with a cotton swab applicator in a “zig-zag” pattern. The inks, modified with UV curable resin and photoinitiator, were exposed to 2 passes at 30 feet per minute with 1-600 watt/inch Fusion Systems “H” bulb.

The water resistance was tested by rubbing a cotton swab applicator, saturated with distilled water, across the test image with 2 double strokes. The test image was rated according to the scale described in Example 1. The results can be found in Table IV below.

TABLE III

| | | Formulation | | Formulation | | Formulation | |
|---|---|---|---|---|---|---|---|
| | | A | | B | | C | |
| | | % UV Resin | | | | | |
| | | 10% | | 20% | | 40% | |
| | Total | | Solid | | Solid | | Solid |
| | Solids | Wet Wt. | Wt. | Wet Wt. | Wt. | Wet Wt. | Wt. |
| Viaktin ® 6166 | 75.% | 0.23 | 0.18 | 0.47 | 0.35 | 0.93 | 0.7 |
| Jetsperse ® | 17.% | 9.26 | 1.58 | 8.24 | 1.40 | 6.18 | 1.05 |
| Diethylene Glycol | 0.% | 2.03 | | 2.06 | | 2.14 | |
| Liponic EG-1 | 0.% | 2.03 | | 2.06 | | 2.14 | |
| Silwet ® L-7607 | 0.% | 0.2 | | 0.21 | | 0.21 | |
| Deionized Water | 0.% | 36.25 | | 36.96 | | 38.39 | |
| Total Diluent Wt. | | 40.5 | | 41.3 | | 42.89 | |
| Total Solid Wt. | | | 1.75 | | 1.75 | | 1.75 |
| Total Weight | | 50. | | 50. | | 50. | |
| Percent Total Solids | | | 3.5% | | 3.5% | | 3.5% |

TABLE IV
Water Resistance

| Photoinitiator Level | Formulation A | Formulation B | Formulation C |
|---|---|---|---|
| 1% on Total Ink Solids | 4 | 4 | 4 |
| 2% on Total Ink Solids | 4 | 4 | 4 |
| 3% on Total Ink Solids | 4 | 4 | 5 |
| 4% on Total Ink Solids | 4 | 4 | 5 |
| 5% on Total Ink Solids | 3 | 4 | 4 |

The results of the water testing of the ink formulations modified with the UV curable resins, followed by UV curing show only slight to no effect when tested with the water moistened cotton swab.

A larger sample of the inks modified with UV curable resin were also charged into the ink cartridge for a Hewlett Packard 680C ink jet based printer. This cartridge was used to demonstrate the printability of the UV resin modified ink of the invention in a typical commercially available printer. UV curable resin modified inks of the invention applied by means of the ink jet printer demonstrate that resins of the invention having a maximum particle size of 70-80 nanometers can be effectively utilized in the ink jet ink formulations of the invention.

### Example 3

Three ink jet ink formulations using an aromatic urethane acrylate UV curable resin (Viaktin® 6165) were prepared by mixing the Viaktin® 6165 resin, Jetsperse® carbon black dispersion, diethylene glycol, Liponic EG-1, Silwet® L-7607, and deionized water. The resulting mixture was stirred until it was completely homogeneous, i.e. uniformly dispersed. A photoinitiator blend (1:2 weight ratio of Lucirin® TPO and IRGACURE® 500) was subsequently added to and mixed with each ink jet formulation in a level of from 1 to 5 weight % based on total ink solids. The ink jet ink formulations prepared are shown in Table V.

The ink jet ink samples, i.e. formulations containing the photoinitiator blend, were then applied to 20 pound Xerox 4024 copying paper with a cotton swab applicator in a “zig-zag” pattern. The inks, modified with UV curable resin and photoinitiator, were exposed to 2 passes at 30 feet per minute with 1-600 watt/inch Fusion Systems “H” bulb.

The water resistance was tested by rubbing a cotton swab applicator, saturated with distilled water, across the test image with 2 double strokes. The test image was rated according to the scale described in Example 1. The results can be found in Table VI below.

TABLE V

| | | Formulation | | Formulation | | Formulation | |
|---|---|---|---|---|---|---|---|
| | | A | | B | | C | |
| | | % UV Resin | | | | | |
| | | 10% | | 20% | | 40% | |
| | Total | | Solid | | Solid | | Solid |
| Component | Solids | Wet Wt. | Wt. | Wet Wt. | Wt. | Wet Wt. | Wt. |
| Viaktin ® 6165 | 45.% | 0.39 | 0.18 | 0.78 | 0.35 | 1.56 | 0.7 |
| Jetsperse ® | 17.% | 9.26 | 1.58 | 8.24 | 1.40 | 6.18 | 1.05 |
| Diethylene Glycol | 0.% | 2.02 | | 2.05 | | 2.11 | |
| Liponic EG-1 | 0.% | 2.02 | | 2.05 | | 2.11 | |
| Silwet ® L-7607 | 0.% | 0.2 | | 0.2 | | 0.21 | |
| Deionized Water | 0.% | 36.11 | | 36.68 | | 37.83 | |
| Total Diluent Wt. | | 40.35 | | 40.99 | | 42.27 | |
| Total Solid Wt. | | | 1.75 | | 1.75 | | 1.75 |
| Total Weight | | 50. | | 50. | | 50. | |
| Percent Total Solids | | | 3.5% | | 3.5% | | 3.5% |

TABLE IV
Water Resistance

| Photoinitiator Level | Formulation A | Formulation B | Formulation C |
|---|---|---|---|
| 1% on Total Ink Solids | 3 | 3 | 5 |
| 2% on Total Ink Solids | 3 | 4 | 5 |
| 3% on Total Ink Solids | 4 | 5 | 5 |
| 4% on Total Ink Solids | 3 | 5 | 5 |
| 5% on Total Ink Solids | 3 | 5 | 5 |

The results of the water testing of the ink formulations modified with the UV curable resins, followed by UV curing show only slight to no effect when tested with the water moistened cotton swab.

A larger sample of the inks modified with UV curable resin were also charged into the ink cartridge for a Hewlett Packard 680C ink jet based printer. This cartridge was used to demonstrate the printability of the UV resin modified ink of the invention in a typical commercially available printer. UV curable resin modified inks of the invention applied by means of the ink jet printer demonstrate that resins of the invention having a maximum particle size of 70-80 nanometers can be effectively utilized in the ink jet ink formulations of the invention.

The results of Examples 1-3 demonstrate the significant improvement in water resistance of images produced using the ink compositions of the invention compared to images produced from commercially available ink jet inks.

We claim:

1. An ink jet ink composition comprising:
(a) an aqueous carrier medium,
(b) a colorant,
(c) a UV curable resin dilutable in said aqueous carrier medium, and
(d) a photoinitiator.

2. The composition of claim 1 wherein said UV curable resin is a urethane acrylate resin.

3. The composition of claim 2 wherein said urethane resin is an aliphatic urethane acrylate resin.

4. The composition of claim 2 wherein said urethane acrylate resin is water dilutable.

5. The composition of claim 1 wherein said UV curable resin is a polyester acrylate resin.

6. The composition of claim 1 wherein said UV curable resin is an epoxy resin.

7. The composition of claim 1 wherein said UV curable resin is physically drying before UV curing.

8. The composition of claim 1 wherein said UV curable resin is about 5 wt. % to about 80 wt. % of said ink jet ink composition on a non-aqueous carrier medium basis.

9. The composition of claim 8 wherein said UV curable resin is about 10 wt. % to about 60 wt. % of said ink jet ink composition on a non-aqueous carrier medium basis.

10. The composition of claim 8 wherein said aqueous carrier medium comprises at least 50 wt. % of said ink jet ink composition.

11. The composition of claim 10 wherein said aqueous carrier medium comprises:
(a) about 30 to 100 wt. % water, and
(b) 0 to about 70 wt. % of at least one co-solvent.

12. The composition of claim 11 wherein said co-solvent is selected from ethylene glycol, propylene glycol, diethylene glycols, glycerine, dipropylene glycols, polyethylene glycols, polypropylene glycols, amides, ethers, carboxylic acids, esters, alcohols, organosulfides, organosulfoxides, sulfones, alcohol derivatives, carbitol, butyl carbitol, cellusolve, ether derivatives, amino alcohols, ketones, N-methyl-pyrrolidinone, N-ethylpyrrolidinone,
2-pyrrolidone, cyclohexylpyrrolidone, hydroxyethers, amides, sulfoxides, lactones, imidazole, or mixtures thereof.

13. The composition of claim 1 wherein said colorant is selected from at least one pigment, at least one dye or mixtures thereof.

14. The composition of claim 2 wherein said photoinitiator is about 1 wt. % to about 8 wt. % of said ink jet ink composition on a non-aqueous carrier medium basis.

15. A method of forming a waterfast image on an image receiving substrate comprising:
(a) applying in imagewise fashion to said image receiving substrate by ink jetting an ink jet ink comprising:
(1) an aqueous carrier medium,
(2) a colorant,
(3) a UV curable resin dilutable in said aqueous carrier medium, and
(4) a photoinitiator; and
(b) thereafter exposing said image receiving substrate to a UV source.

16. The method of claim 15 wherein said UV curable resin is a urethane acrylate resin.

17. The method of claim 16 wherein said urethane acrylate resin is an aliphatic urethane acrylate resin.

18. The method of claim 16 wherein said urethane acrylate resin is water dilutable.

19. The method of claim 15 wherein said UV curable resin is a polyester acrylate resin.

20. The method of claim 15 wherein said UV curable resin is an epoxy resin.

21. The method of claim 15 wherein said UV curable resin is physically drying before UV curing.

22. The method of claim 15 wherein said UV curable resin is about 5 wt. % to about 80 wt. % of said ink jet ink composition on a non-aqueous carrier medium basis.

23. The method of claim 22 wherein said UV curable resin is about 10 wt. % to about 60 wt. % of said ink composition on a non-aqueous carrier medium basis.

24. The method of claim 22 wherein said aqueous carrier medium comprises at least 50 wt. % of said ink jet ink composition.

25. The method of claim 24 wherein said aqueous carrier medium comprises:
(a) about 30 to 100 wt. % water, and
(b) 0 to about 70 wt. % of at least one co-solvent.

26. The method of claim 16 wherein said photoinitiator is about 1 wt. % to about 8 wt. % of said ink jet ink composition on a non-aqueous carrier medium basis.

27. A method to improve the waterfastness of an ink jet image on a substrate, said method comprising adding to an ink jet ink formulation an effective amount of a UV curable resin dilutable in said ink jet ink formulation and an effective amount of a photoinitiator, ink jetting an image on said substrate, and thereafter exposing said substrate to a UV source.

28. The method of claim 27 wherein said UV curable resin is a urethane acrylate resin.

29. The method of claim 28 wherein said urethane acrylate resin is an aliphatic urethane acrylate resin.

30. The method of claim 28 wherein said urethane acrylate resin is water dilutable.

31. The method of claim 27 wherein said UV curable resin is a polyester acrylate resin.

32. The method of claim 27 wherein said UV curable resin is an epoxy resin.

33. The method of claim 27 wherein said UV curable resin is physically drying before UV curing.

34. The method of claim 27 wherein said UV curable resin is about 5 wt. % to about 80 wt. % of said ink jet ink formulation on a non-aqueous carrier medium basis.

35. The method of claim 34 wherein said UV curable resin is about 10 wt. % to about 60 wt. % of said ink jet ink formulation on a non-aqueous carrier medium basis.

36. The method of claim 28 wherein said aqueous carrier medium comprises at least 50 wt. % of said ink jet ink formulation.

37. The method of claim 36 wherein said aqueous carrier medium comprises:
(a) about 30 to 100 wt. % water, and
(b) 0 to about 70 wt. % of at least one co-solvent.

38. The method of claim 28 wherein said photoinitiator is about 1 wt. % to about 8 wt. % of said ink jet ink formulation on a non-aqueous carrier medium basis.

39. An article produced by applying an ink jet ink composition of claim 1 to a substrate, and curing the image formed on said substrate by exposing said substrate to a UV source.

40. An ink jet printer cartridge containing an ink jet ink composition of claim 1.
